(19) United States
(12) Patent Application Publication
(10) Pub. No.: US 2005/0046159 A1
(43) Pub. Date: Mar. 3, 2005

(54) Curtain airbag apparatus

(75) Inventors: Atsushi Noguchi, Moriyama-shi (JP); Yashushi Masuda, Kanzaki-gun (JP)

Correspondence Address: FOLEY AND LARDNER;SUITE 500, 3000 K STREET NW, WASHINGTON, DC, 20007, US

(73) Assignee: TAKATA CORPORATION

(21) Appl. No.: 10/882,180

(22) Filed: Jul. 2, 2004

(30) Foreign Application Priority Data
Sep. 1, 2003 (JP) 2003-308898
Sep. 11, 2003 (JP) 2003-319950
Apr. 22, 2004 (JP) 2004-126958

(51) Int. Cl. B60R 21/22

(52) U.S. Cl. 280/730.2

(57) ABSTRACT

A curtain airbag apparatus in which a curtain airbag can be inflated quickly downward without increasing the output of an inflator. A guide rod for guiding the rear end of a curtain airbag when the curtain airbag is inflated from a roof side downward is attached to a C-pillar of a motor vehicle. The rear end of the curtain airbag is connected to the guide rod via a connecting belt. A space for allowing passage of the connecting belt is defined between a cabin-side surface of the C-pillar and an edge of a pillar garnish. The space is closed by a lip portion of a weather strip mounted to the C-pillar. The connecting belt includes a metallic wire and a rubber tube.

### BACKGROUND

The present invention relates to an installation structure of a curtain air bag deployed along the side surface of a vehicle cabin, and a curtain airbag apparatus.

Airbags have become an important component of a vehicle's safety system. Various types of airbags are known in the art for specific types of uses. One type of airbag known in the art is an airbag having a curtain-like shape, referred to as a curtain airbag, and generally used for deployment on the sides of a vehicle. In a motor vehicle provided with a curtain air bag apparatus, in the case where the motor vehicle is involved in a side collision, is fallen on its side, or is rolled sideways the curtain airbag is inflated downwardly of a vehicle body along the side surface (for example, a door or a pillar) in a vehicle cabin by gas fed from an inflator to protect the head of an occupant, and to prevent the occupant from being thrown out from the vehicle when a window is opened.

In a Japanese Patent Publication No. 3,329,277, an curtain airbag apparatus in which a curtain airbag (in the above-described Patent Publication, it is referred to as “head protecting airbag”) is folded and disposed along a roof side rail at the edge of the vehicle on the ceiling side, and a folded body of the curtain airbag is covered by a roof lining attached to the ceiling of the vehicle is disclosed.

In the curtain airbag apparatus of the same Patent Publication, the side portion of the roof lining engages a cabin side member (the upper surface of a mounting portion for an assist grip in an embodiment in the same Patent Publication). When this curtain airbag initiates its inflation by gas fed from the inflator, the curtain airbag which is in the course of inflation presses the roof lining, and disengages the side portion of the roof lining from the vehicle side member in the first place, and subsequently inflates downward while pressing and opening the roof lining.

There is a case in which the apparatus is configured in such a manner that when arranging the folded body of the curtain airbag along the roof side rail and covering the same by the roof lining, a presumptive portion to be torn, such as a tear line, is provided on the roof lining, so that the roof lining is torn by a pressing force (internal pressure) of the curtain airbag when the curtain airbag is inflated.

U.S. Pat. No. 6,237,938 (incorporated by reference herein) discloses provision of a guide member for guiding the rear end of the curtain airbag which is inflated along the side surface in the cabin downwardly of the vehicle body along the pillar on a C-pillar.

The guide member of the same patent includes a member shaped like a box in cross section, which is referred to as a track, and a slider member disposed in the track and movable in the longitudinal direction of the track, which is referred to as an element, and a connecting belt provided at the rear end of the curtain airbag, which is referred to as a tether, is tied-in with the element. In order to prevent the slider member and the rear end of the curtain airbag having moved downward from returning upward, one-way clutches are provided substantially along the whole length of the track at regular intervals.

Mounting flanges are provided at the upper end and the lower end of the track, and each flange is attached to the C-pillar with a bolt or a screw.

Thus, there is a need for an curtain airbag apparatus which provides adequate protection to a vehicle occupant while conforming to industry standards and minimizing cost and design impact on the vehicle.

In the curtain airbag apparatus in the related art as described above, it is necessary to increase the internal pressure of the curtain airbag to the level which is sufficient for disengaging the side portion of the roof lining from the cabin side member or tearing the roof lining prior to downward inflation of the curtain airbag along the side surface of the cabin. Therefore, it is necessary to employ the inflator having a high output in order to allow the curtain airbag to be inflated quickly downward.

### SUMMARY

In a curtain airbag installation structure and a curtain airbag apparatus according to an embodiment of the present invention, when the inflator is activated and the of the vehicle, the curtain airbag is inflated downward passing through the region or space between the side portion of the roof lining and the roof side rail. Though the space is closed by the closing member, the closing member is provided with the deformation inducing means for inducing deformation of the closing member so as to open the space as the curtain airbag moves downward through the space, and hence the curtain airbag can pass through the space easily while deforming the closing means.

Therefore, since the curtain airbag can be inflated downward through the space even when the internal pressure is relatively low, the curtain airbag can be inflated quickly downward without increasing the output of the inflator. Since the space is closed by the closing member in the normal state, the space is indistinctive and hence a good appearance can be maintained. Also, foreign matters such as dust or dirt are prevented from entering through the space into the backside of the roof lining. The recessed groove is preferable as the deformation inducing means since the structure is simple.

A curtain airbag is disposed along a roof side rail of a motor vehicle in the state of being folded into an elongated shape extending in the fore-and-aft direction. A folded body of the curtain airbag 1 is covered by a roof lining attached to the ceiling portion of the vehicle. A space or region for allowing passage of the curtain airbag in the course of inflation is formed between an end edge of the roof lining and a cabin side surface of a roof side rail. The space is closed by a lip portion projecting toward the cabin from a weather strip attached to the roof side rail. The lip portion is provided with a deformation inducing portion (recessed groove) for inducing bending deformation thereof so that the lip portion leaves the space as the curtain airbag which is in the course of inflation passes through the space.

Generally, the guide member described above is covered by a pillar garnish. When the curtain airbag is inflated, the end of the curtain airbag, i.e. the connecting belt, slides and moves downward with respect to the pillar garnish so as to tear the pillar garnish, or to move the side portion of the pillar garnish away from the pillar.

It may be configured such that a space is provided between the pillar garnish and the pillar, and the space is closed by a weather strip. In this case, when the curtain airbag is deployed, the connecting belt moves downward so as to deform the weather strip and open the space.

According to the configuration in the related art, since the connecting belt slides with respect to the pillar garnish or the weather strip when the curtain airbag is deployed as described above, it is necessary to provide the connecting belt a strength that can resist sliding friction, and hence to employ a thick or wide connecting belt to a certain extent.

However, in the curtain airbag apparatus of the present invention, when the inflator is activated and the curtain airbag is inflated downward in case of emergency of the vehicle, the connecting belt moves downward along the guide member. In this case, although the connecting belt slides with respect to the interior member of the vehicle and hence is subjected to friction, since the portion that comes into contact with the interior member of the vehicle is formed of metallic wire, it is prevented from becoming damaged by friction. Since the metallic wire has a high strength, the one with a small diameter can be employed. By covering the metallic wire with rubber or resin, its corrosion resistivity increases. Also, the metallic wire is prevented from coming into direct contact with the weather strip or the pillar garnish and hence partly cutting or giving damages to them.

According to the configuration in the related art, frictional drag generated when the end of the curtain airbag slide with respect to the pillar garnish is significant as described above. Therefore, it was necessary to employ an inflator having high output power in order to allow the curtain airbag to be inflated quickly.

According to the guide mechanism for the curtain airbag of the present invention, when the inflator is activated and hence the curtain airbag is inflated downward in case of emergency of the vehicle, the end of the curtain airbag moves downward along the guide member. In this case, the end of the curtain airbag passes in the space between the side portion of the pillar garnish and the cabin-side surface of the pillar. While the space is closed by the closing member, since the closing member is provided with deformation guiding means for guiding the closing member to deform so as to open the space as the end of the curtain airbag moves downward in the space, the end of the curtain airbag moves in the space while easily deforming the closing member.

Therefore, in comparison with the related art in which the end of the curtain airbag tears the pillar garnish, or moves the pillar garnish downward while sliding the same in the direction away from the pillar, a resistance force applied to the end of the curtain airbag is small, and hence the curtain airbag can quickly be inflated downward without increasing the output power of the inflator.

Since the space is closed by the closing member in a normal state, the space is not easily visible, and hence does not impair the appearance. It also prevents foreign substances such as dirt or dust from entering through the space into the pillar garnish. As the deformation guiding means, a recessed groove is preferable since the configuration is simple.

According to the present invention, the curtain airbag may be configured in such a manner that a connecting belt extending from the end thereof is provided, the connecting belt is connected to the guide member, and the connecting belt passes through the space when the curtain airbag is deployed downward.

In this arrangement, the connecting belt slides with respect to the closing member when the curtain airbag is inflated, and hence the frictional drag with respect to the closing member can further be reduced.

It is an object of the present invention to provide a curtain airbag installation structure and a curtain airbag apparatus in which the curtain airbag can be inflated quickly downward without increasing the output of the inflator.

It is an object of the present invention to provide a curtain airbag apparatus which can sufficiently resist friction applied when the curtain airbag is deployed even when the connecting belt is thin.

It is an object of the present invention to provide a guide mechanism for a curtain airbag for allowing the curtain airbag to inflate quickly downward without increasing the output power of the inflator.

It is to be understood that both the foregoing general description and the following detailed description are exemplary and explanatory only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1(a) and 1(b) are a schematic side views of a vehicle cabin having a structure according to an embodiment;

FIG. 2(a) is a cross-sectional view taken along the line II-II in FIG. 1(a), and FIG. 2(b) is a cross-sectional view of the same portion when a curtain airbag is inflated;

FIG. 3(a) and 3(b) is a schematic side view of a vehicle cabin provided with a guide mechanism of a curtain airbag according to one embodiment of the present invention;

FIG. 4(a) is a cross-sectional view taken along the line II-II in FIG. 3(a), and (b) is a cross-sectional view showing a state in which a connecting belt passes through the portion of the cross-section in the drawing (a);

FIG. 5 is a perspective view showing the curtain airbag and a guide rod with the curtain airbag in a folded position; and

FIG. 6 is a perspective view showing the curtain airbag and a guide rod with the curtain airbag deployed.

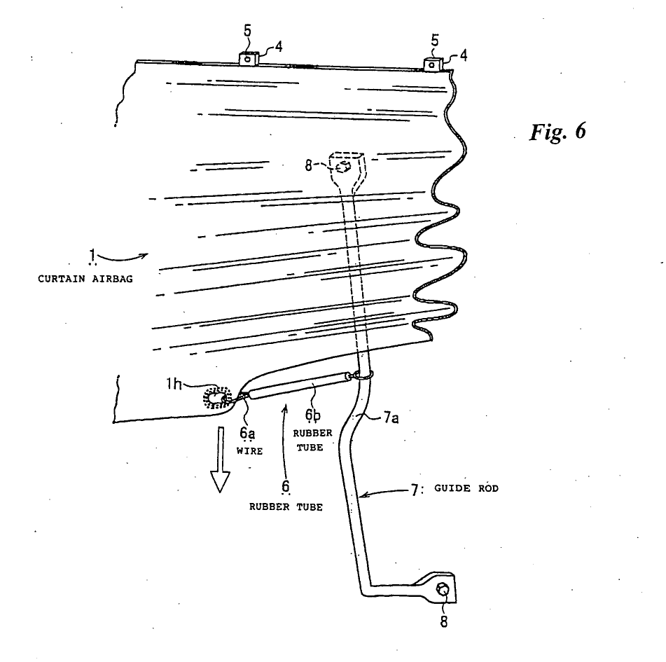

### DETAILED DESCRIPTION

The present invention relates to a curtain airbag apparatus which provides adequate protection to a vehicle occupant while minimizing cost and design impact on the vehicle.

A curtain airbag structure of the present invention includes a folded body of a curtain airbag disposed along a roof side rail at the edge of the vehicle on the ceiling side, and the folded body of the curtain airbag being covered by the roof lining attached to the ceiling of the vehicle, and is characterized in that a region or space for allowing the curtain airbag to pass is formed between the side portion of the roof lining and the roof side rail, the space is closed by a closing member, and the closing member is provided with deformation inducing means for inducing deformation of the closing member so as to open the space as the curtain airbag moves downward through the space.

The curtain airbag installation structure in one embodiment is characterized in that a recessed groove is provided as the deformation inducing means.

A curtain airbag apparatus according to the present invention includes a curtain airbag folded and disposed along a roof side rail at the edge of the vehicle on the ceiling side, and an inflator for inflating the curtain airbag, and is characterized in that a folded body of the curtain airbag is covered by a roof lining attached to the ceiling of the vehicle, a space for allowing the curtain airbag to pass is formed between the side portion of the roof lining and the roof side rail, the space is closed by a closing member, and the closing member is provided with deformation inducing means for inducing deformation of the closing member so as to open the space as the curtain airbag moves downward through the space.

Referring to the attached drawings, an embodiment of the present invention will be described below.

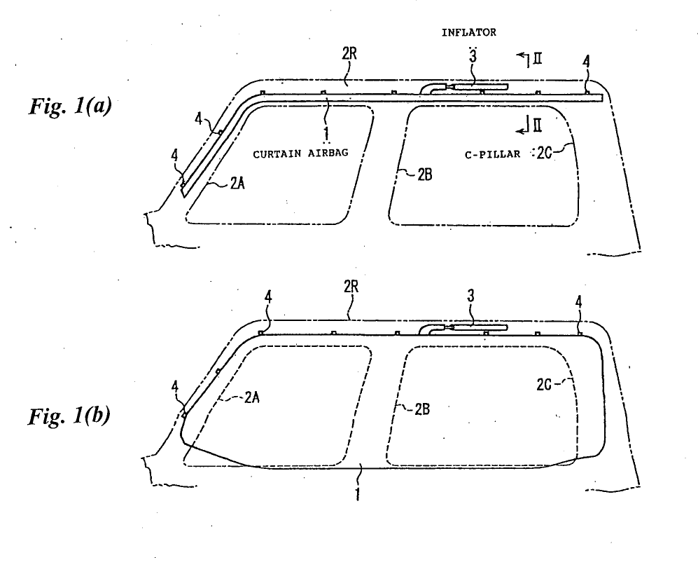

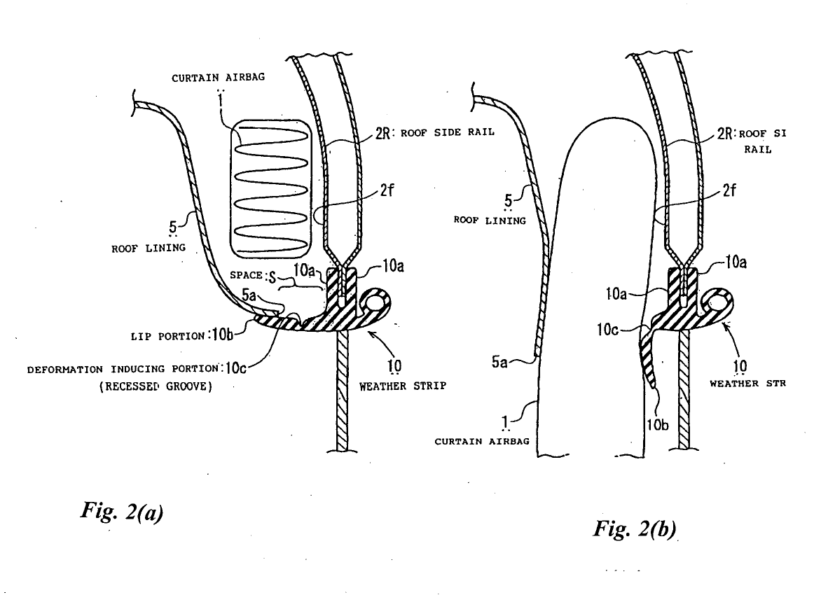

FIG. 1 is a schematic side view showing the interior of the vehicle cabin having a structure according to an embodiment, in which (a) shows a curtain airbag which is not inflated, and (b) shows the curtain airbag which is inflated. FIG. 2(a) is a cross sectional view taken along the lint II-II in FIG. 1(a), and FIG. 2(b) is a cross sectional view showing the same portion as FIG. 2(a) when the curtain airbag is inflated.

In this embodiment, a curtain airbag 1 is arranged from an A-pillar 2A to a roof side rail 2R of a motor vehicle in a state of being folded into an elongated shape extending in the fore-and-aft direction. The rear portion of the curtain airbag 1 is extended to the upper portion of a C-pillar 2C. The reference numeral 2B shows a B-pillar. The curtain airbag 1 starts inflation by gas fed from an inflator 3 when the motor vehicle is involved in a side collision or is fallen on its side, and is inflated an deployed downward of the vehicle body along the side surface in the cabin, such as a door or the respective pillars 2A, 2B, 2C.

The upper edge of the curtain airbag 1 is provided with a lug 4, and the lug 4 is attached to the roof side rail 2R by a fastening member (not shown) such as bolts, rivets, and so on. The front end of the curtain airbag 1 is attached to the A-pillar 2A.

A roof lining (interior panel) 5 is attached so as to cover the cabin side of the vehicle ceiling. A folded body of the curtain airbag 1 is disposed on the backside of the side edge of the roof lining 5.

As shown in the drawings, a space S is formed between the end edge 5a of the side edge of the roof lining 5 and a cabin side surface 2f of the roof side rail 2R. The space S is smaller than the thickness of the curtain airbag 1 in the completely inflated state, but has a size that allows the curtain airbag 1 to pass therethrough in the initial stage of inflation in which the thickness is still small (the state immediately after the folded state is released and downward inflation is initiated) as shown in FIG. 2(b).

The roof lining 5 is configured to be pressed by the curtain airbag 1 and opened toward the cabin to enlarge the space S as the curtain airbag 1 initiates its downward inflation, passes through the space S, and gradually increases in thickness.

As shown in FIG. 2, a weather strip 10 formed of rubber or synthetic resin or the like is attached to the roof side rail 2R. The weather strip 10 has clamping portions 10a including a pair of parallel strips, and the weather strip 10 is secured to the roof side rail 2R with the clamping portions 10a, 10a clamped on a flange (lower edge) of the roof side rail 2R.

The weather strip 10 includes a lip portion 10b extending toward the cabin, and the lip portion 10b overlaps the side edge of the roof lining 5 and closes the space S as shown in FIG. 2(a).

The lip portion 10b is provided with a deformation inducing portion 10c for inducing bending deformation of the lip portion 10b so as to leave the space S by being pressed by the curtain airbag 1 which is in the course of inflation. In this embodiment, the deformation inducing portion 10c is formed of a recessed groove formed on the back surface of the lip portion 10b as shown in FIG. 2(a).

When the vehicle having the curtain airbag installation structure or the curtain airbag apparatus configured as described above is involved into an emergency state such as a side collision or falling sideways, the inflator 3 is activated and injects gas. With gas from the inflator 3, the curtain airbag 1 starts inflation. The curtain airbag 1 is inflated downward through the space S. Although the space S is closed by the lip portion 10b of the weather strip 10, since the lip portion 10b is formed with the deformation inducing portion (the recessed groove) 10c, the curtain airbag 1 can pass through the space S while bending the lip portion 10b easily. Therefore, since the curtain airbag 1 can inflate downward through the space S even when the inner pressure is relatively low, and hence the curtain airbag 1 can be inflated quickly downward without increasing the output of the inflator 3.

The curtain airbag 1 passed through the space S is inflated downwardly along the side surface of the cabin and increases in thickness while opening the roof lining 5. The curtain airbag 1 thus inflated receives the occupant to absorb an impact and prevents the occupant from being thrown out of the vehicle.

Another aspect of a curtain airbag apparatus according to the present invention includes a curtain airbag which is deployed downward along the side surface in a vehicle cabin, a guide member extending in the vertical direction and attached to the pillar of a vehicle, and a connecting belt extending from the curtain airbag and connecting to the guide member, and is characterized in that the connecting belt is formed of metallic wire at the portion which comes into contact with an interior member of the vehicle at least when the curtain airbag is deployed. According to an embodiment of the present invention, the metallic wire is coated by rubber or resin.

According to an embodiment of the present invention, the interior member of the vehicle includes a pillar garnish mounted to the pillar of the vehicle and covering the guide member, and a closing member for closing a space defined between the side portion of the pillar garnish and the cabin-side surface of the pillar, and when the connecting belt moves downward in the space upon deployment of the curtain airbag, the closing member is pressed by the connecting belt and is deformed so as to open the space.

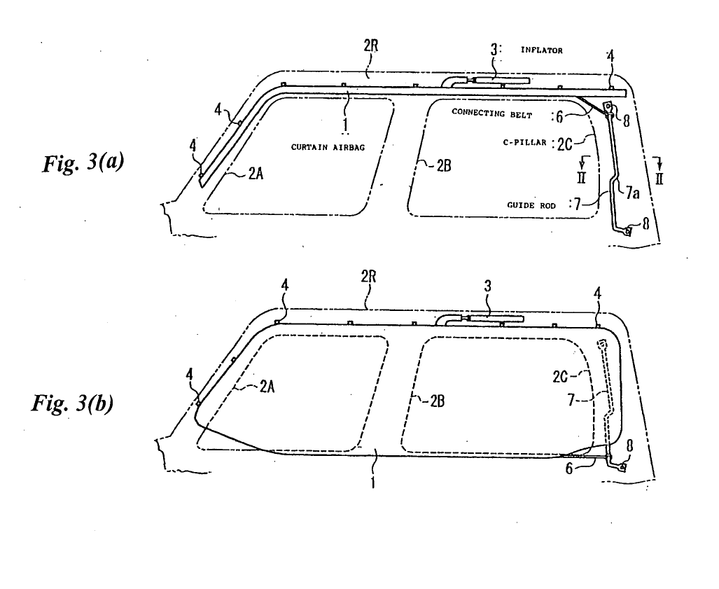

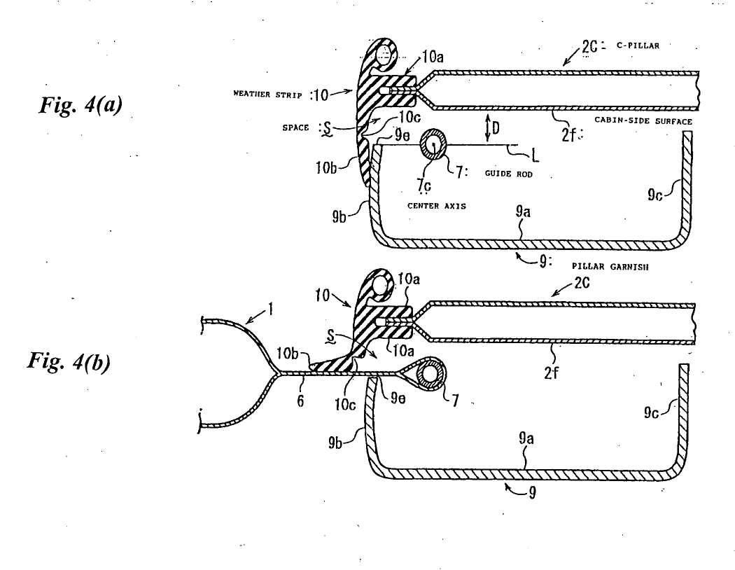

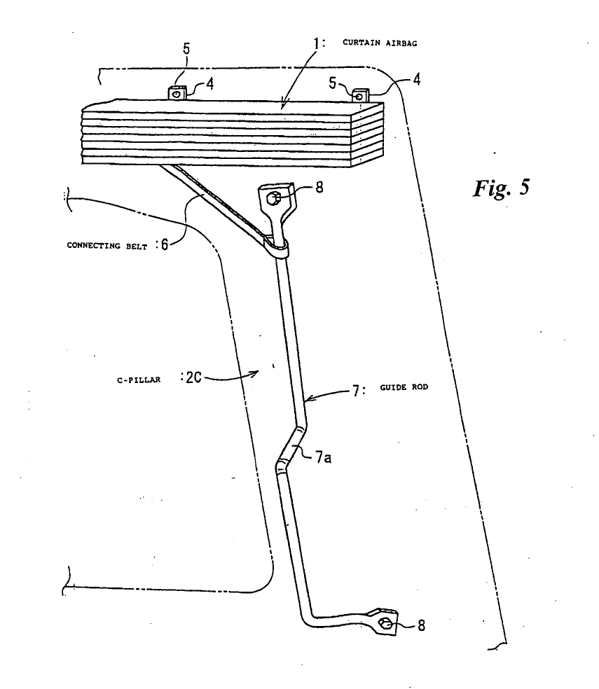

Another aspect of the present invention is illustrated in FIG. 3. FIG. 3 is a schematic side view of a vehicle cabin provided with a guide mechanism for a curtain airbag according to one embodiment of the present invention, in which (a) shows the curtain airbag in the non-inflated state, and (b) shows the curtain airbag in the inflated state. FIG. 4(a) is a cross-sectional view taken along the line II-II in FIG. 3(a), and FIG. 4(b) is a cross-sectional view showing a state in which a connecting belt passes through the portion of the cross-section in FIG. 4(a). FIG. 5 is a perspective view showing the curtain airbag and a guide rod.

In this embodiment, a curtain airbag 1 is disposed from an A-pillar 2A to a roof side 2R of a motor vehicle in a state of being folded longitudinally in the fore-and-aft direction. The rear portion of the curtain airbag 1 extends up to the portion above a C-pillar 2C. Reference sign 2B designates a B-pillar. The curtain airbag 1 starts inflating by a supply of gas from an inflator 3 when the motor vehicle is subjected to a side collision or turned sideways, and is inflated and deployed downwardly of the vehicle body along the side surface in the cabin, such as a door and the respective pillars 2A, 2B, and 2C.

As shown in FIG. 3, lugs 4 are provided on the upper edge of the curtain airbag 1, and the lugs 4 are secured to the roof side portion 2R with fixtures 5 such as bolts or rivets. The front end of the curtain airbag 1 is secured to the A-pillar 2A.

An end of a connecting belt 6 is connected to the rear portion of the lower edge of the curtain airbag 1. In this embodiment, the connecting belt 6 includes a metallic wire 6a and a rubber tube 6b for covering the metallic wire 6a.

A small hole 1h is formed at the rear portion of the lower edge of the curtain airbag 1, and the loop-shaped front end of the wire 6a is inserted into the small hole 1h. The periphery of the small hole 1h is reinforced by a patch cloth (filler cloth) or by reinforcing stitches.

The rear end of the wire 6a is also formed into a loop, and the loop-shaped portion is slidably fitted on the guide rod 7. It is also possible to provide a ring at the end of the wire 6a and engage the ring with the small hole 1h or a guide rod 7. The rubber tube 6b is fitted on the linear portion of the wire 6a except for the loops at the front end and the rear end.

The guide rod 7 as a guiding member for guiding the rear end of the curtain airbag 1 along the C-pillar 2C via the connecting band 6 when the curtain airbag 1 is inflated downwardly of the vehicle body along the C-pillar 2C is mounted to the C-pillar 2C of the motor vehicle. The guide rod 7 extends in the vertical direction of the vehicle body along the C-pillar 2C.

The guide rod 7 extends entirely or partly of the range of movement of the end of the curtain airbag 1 from a state in which the curtain airbag 1 is folded to a state in which downward deployment is completed.

The guide rod 7 is formed of a rod-shaped member and is fixed to the C-pillar 2C with bolts 8 at the upper end and the lower end. The intermediate portion of the guide rod 7 is bent into substantially a crank shape, whereby an anchoring portion 7a for the connecting band 6 is provided. The anchoring portion 7a serves as a stopper for preventing the connecting belt 6 from being retracted upwardly of the anchoring portion 7a. The guide rod 7 is positioned apart from a cabin-side surface 2f of the C-pillar as a whole by a predetermined distance except for the upper and lower ends thereof.

A pillar garnish 9 is provided so as to cover the cabin side of the C-pillar 2C. The pillar garnish 9 has a substantially angular C-shape in cross section, and includes a main plate portion 9a which extends substantially parallel with the cabin side surface 2f of the C-pillar 2C, and side plate portions 9b, 9c standing from the main plate portion 9a toward the C-pillar 2C. The side plate portion 9b is positioned on the door-side of the C-pillar 2C. There is provided a space S for allowing the connecting belt 6 to pass downward between an edge 9e of the side plate portion 9b on the side of the C-pillar 2C and the cabin-side surface f of the C-pillar 2C.

The distance between the edge 9e and the cabin-side surface 2f is shown as D in FIG. 4(a). The distance D is defined as a distance between a line L which passes the edge 9e and extends in parallel with the cabin side surface 2f and the cabin side surface 2f. In this embodiment, a center axis 7c of the guide rod 7 is positioned above the line L or on the side of the cabin-side surface 2f with respect thereto. Accordingly, the distance between the center axis 7c and the cabin-side surface 2f is equal to, or smaller than, the distance D between the edge 9e and the cabin-side surface 2f.

As shown in FIG. 4, a weather strip 10 formed of rubber, synthetic resin, or the like is mounted to the C-pillar 2C. The weather strip 10 includes clamping portions 10a formed of a pair of parallel strips, and the weather strip 10 is secured to the C-pillar 2C so that the clamping portions 10a, 10a clamp a flange of the C-pillar 2C.

The weather strip 10 includes a lip portion 10b extending toward the cabin, and the lip portion 10b closes the space S by overlapping the side plate portion 9b of the pillar garnish 9.

The lip portion 10b is provided with a deformation guiding portion 10c for guiding curvature deformation of the lip portion 10b so as to move away from the space S as the connecting band 6 passes through the space S. In this embodiment, the deformation guiding portion 10c is formed of a recessed groove extending in the vertical direction formed on the backside (the surface facing the inner side of the pillar garnish 9 via the space S) of the lip portion 10b as shown in FIG. 4(a).

Although not shown in the drawing, an A-pillar garnish provided on the A-pillar 2A, and a roof side garnish provided on the roof side 2R cover the folded body of the curtain airbag 1.

In a guide mechanism for the curtain airbag thus configured, when the inflator 3 is activated upon the side collision, sideway roll-over or the like of a vehicle, the curtain airbag 1 starts inflating. The curtain airbag 1 pushes and opens the A-pillar garnish and the roof-side garnish or breaks along a weakened line which is formed in advance, and then is deployed downward along the side surface in the vehicle cabin. At the rear portion of the curtain airbag, upon deployment, the connecting belt 6 moves along the guide rod 7, and the curtain airbag 1 finally reaches the lower portion of the guide rod 7 as shown in FIG. 3(b), so that the curtain airbag 1 becomes a tensed state with the lower edge thereof tightened. The curtain airbag 1 thus inflated can receive an occupant and absorb impact, as well as prevents the occupant from being thrown out of the vehicle.

When the connecting belt 6 of the curtain airbag 1 moves along the guide rod 7 as described above, as shown in FIG. 4(b), the connecting belt 6 moves downward in the space S as if it driven away the lip portion 10b of the weather strip 10. Since the lip portion 10b is provided with the deformation guiding portion 10c, the connecting belt 6 passes through the space S while bending the lip portion 10b easily toward the cabin.

In this case, although the connecting belt 6 receives frictional drag from the weather strip 10 or the pillar garnish 9, since the main body of the connecting belt 6 is formed of the metallic wire 6a, the connecting rod 6 can sufficiently resists friction, and the curtain airbag 1 and the guide rod 7 are connected until the final deployed configuration is obtained.

Since the portion of the metallic wire 6a except for the loop portion at both ends is covered with the rubber tube 6b, the metallic wire 6a is prevented from cutting or giving damages to the weather strip 10 or the pillar garnish 9.

A guide mechanism for a curtain airbag according to the present invention is a guide mechanism for guiding the end in the fore-and-aft direction of the curtain airbag which is deployed downward along the side surface in a vehicle cabin, including a guide member for the curtain airbag extending in the vertical direction and attached to a pillar of the vehicle, and a pillar garnish attached to the pillar and covering the guide member, characterized in that a space for allowing passage of the end of the curtain airbag is defined between the side portion of the pillar garnish and the cabin-side surface of the pillar, the space is closed by a closing member, and the closing member is provided with a bending motion guiding means for guiding the closing member to bend in the direction away from the space as the end of the curtain airbag moves downward in the space.

The curtain airbag apparatus according to the present invention includes a curtain airbag deploying downward along the side surface in the vehicle cabin, a guide mechanism for a curtain airbag for guiding the end in the fore-and-aft direction of the curtain airbag having a guide member for a curtain airbag extending in the vertical direction and being attached to the pillar of the vehicle, a pillar garnish attached to the pillar and covering the guide member, characterized in that the guide mechanism for the curtain airbag is the guide mechanism for the curtain airbag according to the present invention.

The curtain airbag 1 is provided with the connecting belt 6 extending rearward from the rear portion thereof. The extremity of the connecting belt 6 is wound around the guide rod 7, so as to be capable of moving along the guide rod 7. It is also possible to provide a ring at the extremity of the connecting belt 6 and fit the ring loosely on the guide rod 7.

The lip portion 10b is provided with a deformation guiding portion 10c for guiding curvature deformation of the lip portion 10b so as to move away from the space S as the connecting band 6 passes through the space S. In this embodiment, the deformation guiding portion 10c is formed of a recessed groove extending in the vertical direction formed on the backside (the surface facing the inner side of the pillar garnish 9 via the space S) of the lip portion 10b as shown in FIG. 4(a).

Although not shown in the drawing, an A-pillar garnish provided on the A-pillar 2A, and a roof side garnish provided on the roof side 2R cover the folded body of the curtain airbag 1.

In a guide mechanism of the curtain airbag thus configured, when the inflator 3 is activated upon the side collision, sideway roll-over or the like of a vehicle, the curtain airbag 1 starts inflating. The curtain airbag 1 pushes and opens the A-pillar garnish and the roof-side garnish or breaks along a weakened line which is formed in advance, and then is deployed downward along the side surface in the vehicle cabin. At the rear portion of the curtain airbag, upon deployment, the connecting belt 6 moves along the guide rod 7, and the curtain airbag 1 finally reaches the lower portion of the guide rod 7 as shown in FIG. 3(b), so that the curtain airbag 1 becomes a tensed state with the lower edge thereof tightened. The curtain airbag 1 thus inflated can receive an occupant and absorb impact, as well as prevents the occupant from being thrown out of the vehicle.

When the connecting belt 6 of the curtain airbag 1 moves along the guide rod 7 as described above, as shown in FIG. 4(b), the connecting belt 6 moves downward in the space S as if it drives the lip portion 10b of the weather strip 10 away. Since the lip portion 10b is provided with the deformation guiding portion 10c, the connecting belt 6 passes through the space S while bending the lip portion 10b easily toward the cabin.

Therefore, in comparison with the related art in which the connecting belt 6 tears the pillar garnish 9, or moves downward while sliding the pillar garnish 9 in the direction away from the C-pillar 2C, a resistance force applied to the connecting belt 6 is small, and hence the curtain airbag 1 can quickly be inflated downward without increasing the output power of the inflator 3.

Although there may be a case in which the connecting belt 6 slides with respect to the edge 9e of the pillar garnish 9 when the connecting belt 6 passes in the space S, in this embodiment, since the center axis 7c of the guide rod 7 is positioned on the line L or on the side of the cabin-side surface 2f with respect thereto as described above, frictional force between the connecting belt 6 and the edge 9e is extremely small. Therefore, the connecting belt 6 moves smoothly along the guide rod 7.

The above-described embodiment is simply an example of the present invention, and the present invention may take other forms other than that described above. For example, while the curtain airbag 1 is connected to the guide rod 7 via the connecting belt 6 in the embodiment described above, the main body of the curtain airbag may be connected to the guide rod. It is also possible to employ a guide member other than the guide rod.

While the guide member (guide rod) is mounted to the C-pillar in the above-described embodiment, it is also possible to mount the guide member to the pillars other than the C-pillar (for example, the B-pillar or the D-pillar).

The above described embodiment is simply an example of the present invention, and other modifications other than that shown above are also possible. For example, although the metallic wire 6a of the connecting belt 6 is covered by the rubber tube 6b in the above-described embodiment, it may be covered by a synthetic resin tube. Alternatively, the metallic wire can be coated by applying rubber or resin. The front end which comes into contact with the small hole 1h can also be coated with rubber or resin. When the coating resin is highly slidable, the portion which slight on the guide rod 7 can also be coated by such a resin.

While the guide member (guide rod) is mounted to the C-pillar in the above-described embodiment, it is also possible to mount the guide member to the pillars other than the C-pillar (for example, the B-pillar or the D-pillar).

In the present invention, a member other than the weather strip may be used as a closing member for the space S. In the present invention, it is also possible to form a space for allowing the curtain airbag to pass through between a pillar garnish provided along the A-pillar and the A-pillar and close the space with a closing member having deformation inducing means. In the present invention, material of the guide rod is not specifically limited, and may be various materials such as metal, synthetic resin, and so on. While the guide rod is a tubular member having a hollow circular cross section as shown in the drawings in the above-described embodiment, it may take the form of a solid rod, and the cross-section can take various configurations. The metallic wire maybe a stainless wire, for example. The wire can be a single wire, or may be a stranded cable (wire rope).

The three priority applications, Japanese Patent Application Nos. 2003-308898, filed Sep. 1, 2003; 2003-319950, filed Sep. 11, 2003; and, 2004-126958, filed Apr. 22, 2004 including the specifications, drawings, claims and abstracts, are incorporated herein by reference in its entirety.

Given the disclosure of the present invention, one versed in the art would appreciate that there may be other embodiments and modifications within the scope and spirit of the present invention. Accordingly, all modifications attainable by one versed in the art from the present disclosure within the scope and spirit of the present invention are to be included as further embodiments of the present invention. The scope of the present invention accordingly is to be defined as set forth in the appended claims.

1. A curtain airbag structure for a vehicle, comprising:
a folded body of a curtain airbag disposed along a roof side rail at the edge of the vehicle on the ceiling side and being at least partially covered by a roof lining of the vehicle;
a region for allowing the curtain airbag to pass therethrough, the region formed between the side portion of the roof lining and the roof side rail;
a closing member adapted to open and close the region; and
the closing member is provided with means for inducing deformation of the closing member so as to open the pass-through mechanism as the curtain airbag moves downward therethrough.

2. The curtain airbag structure of claim 1, wherein the inducing means comprises a recessed groove.

3. The curtain airbag structure of claim 1, further comprising a guide member for a curtain airbag for guiding an end in the fore-and-aft direction of a curtain airbag which is deployed downward along the side surface in a vehicle cabin.

4. The curtain airbag structure of claim 3, wherein the guide member extends in the vertical direction and is attached to a pillar of the vehicle; and wherein a connecting belt extends from the curtain airbag and connects to the guide member.

5. The curtain airbag structure of claim 4, wherein the connecting belt is formed of a metallic wire at a portion which comes in contact with an interior member of the vehicle at least when the curtain airbag is deployed.

6. The curtain airbag structure of claim 5, wherein the metallic wire is coated by rubber or resin.

7. The curtain airbag structure of claim 4, wherein:
the interior member of the vehicle comprises a pillar garnish mounted to the pillar of the vehicle and covering the guide member, and a closing member for closing a space defined between the side portion of the pillar garnish and the cabin-side surface of the pillar; and
wherein the connecting belt moves downward in the space upon deployment of the curtain airbag, the closing member is pressed by the connecting belt and is deformed so as to open the space.

8. The curtain airbag structure of claim 3 wherein the guide mechanism comprises a guide member for the curtain airbag extending in the vertical direction and attached to a pillar of the vehicle, and a pillar garnish attached to the pillar and covering the guide member.

9. The curtain airbag structure of claim 3, wherein the region is further defined between the side portion of the pillar garnish and the cabin-side surface of the pillar.

10. A curtain airbag apparatus for a vehicle cabin comprising:
a curtain airbag being deployable downward along a side surface of the vehicle cabin; and
a guide mechanism for guiding the end in a fore-and-aft direction of the curtain airbag comprising;
a guide member for a curtain airbag extending in the vertical direction and being attached to a pillar of the vehicle cabin; and
a pillar garnish attached to the pillar and covering the guide member.

11. A curtain airbag apparatus of claim 10, wherein a side portion of the pillar garnish and a cabin-side surface of the pillar define a region.

12. A curtain airbag aparatus of claim 11, further comprising a closing member having a means for guiding the closing member to deform wherein the region is adapted to open as the end of the curtain airbag moves downward therethrough.

13. A curtain airbag apparatus of claim 11, wherein the deformation guiding means comprises a recessed groove.

14. A curtain airbag apparatus of claim 12, further comprising a connecting belt extends from the curtain airbag and connects to the guide member.

15. A curtain airbag apparatus for a vehicle, comprising:
a curtain airbag folded and disposed along a roof side rail at the edge of the vehicle on a ceiling side, and
an inflator for inflating the curtain airbag,
the folded body of the curtain airbag being attached to a ceiling of the vehicle;
a region for allowing the curtain airbag to pass is formed between a side portion of the roof lining and a roof side rail, the region is closed by a closing member; and
the closing member is provided with deformation inducing means for inducing deformation of the closing member so as to open the region as the curtain airbag moves downward through the region.

16. The curtain airbag apparatus according to claim 15, wherein the deformation inducing means is a recessed groove.

17. The curtain airbag apparatus of claim 15, further comprising a guide member for a curtain airbag for guiding an end in a fore-and-aft direction of the curtain airbag which is deployed downward along a side surface in the vehicle.

18. A curtain airbag apparatus of claim 17, further comprising a connecting belt extending from the curtain airbag and connecting to the guide member.

19. A curtain airbag apparatus comprising:
a curtain airbag configured to deploy downward along the side surface in a vehicle cabin;
a guide member extending in the vertical direction and attached to a pillar of the vehicle; and
a connecting belt extending from the curtain airbag and connecting to the guide member; wherein the connecting belt is formed of metallic wire at the portion which comes into contact with an interior member of the vehicle at least when the curtain airbag is deployed.

20. A curtain airbag apparatus of claim 19, wherein the connecting belt extends from the end thereof and is connected to the guide member, and the connecting belt passes through the region when the curtain airbag is deployed downward.
